(19) United States
(12) Patent Application Publication
(10) Pub. No.: US 2024/0134249 A1
(43) Pub. Date: Apr. 25, 2024

(54) CAMERA MODULE

(71) Applicant: Samsung Electro-Mechanics Co., Ltd., Suwon-si (KR)

(72) Inventor: Su Kyeong KIM, Suwon-si (KR)

(73) Assignee: Samsung Electro-Mechanics Co., Ltd., Suwon-si (KR)

(21) Appl. No.: 18/129,236

(22) Filed: Mar. 30, 2023

(30) Foreign Application Priority Data
Oct. 23, 2022 (KR) 10-2022-0137686

(51) Int. Cl. G03B 5/00; G03B 17/12

(52) U.S. Cl. CPC G03B 5/00; G03B 17/12; G03B 2205/0069; H04N 23/54

(57) ABSTRACT

A camera module includes a lens module including a lens barrel accommodating a plurality of lenses disposed along an optical axis, and a lens holder coupled to the lens barrel, a carrier accommodating the lens module, a first driver configured to provide a driving force to move the lens module in an optical axis direction, a first ball assembly and a second ball assembly configured to guide the lens module as the lens module moves in the optical axis direction, a housing accommodating the carrier, and a case coupled to the housing. The case includes a step portion opposing the first ball assembly in the optical axis direction. An upper end of the housing opposing the step portion in the optical axis direction is lower than an upper end of the carrier in the optical axis direction.

### CROSS-REFERENCE TO RELATED APPLICATION

This application claims the benefit under 35 USC 119(a) of Korean Patent Application No. 10-2022-0137686 filed on Oct. 24, 2022, in the Korean Intellectual Property Office, the entire disclosure of which is incorporated herein by reference for all purposes.

### BACKGROUND

### 1. Field

The present disclosure relates to a camera module.

### 2. Description of Related Art

Recently, cameras have been basically adopted in portable electronic devices such as smartphones and tablet PCs. An autofocus function (AF), an optical image stabilization (OIS) function, and a zoom function have been added to cameras for mobile terminals.

When a lens module is moved in an optical axis direction for autofocus adjustment, a plurality of ball members may be used to support movement of the lens module. In this case, a case of the camera module may have a protrusion protruding toward the plurality of ball members to prevent the plurality of ball members from separating and to limit a rollable range thereof.

However, as a depth of the protrusion formed on the case increases, molding defects are highly likely to occur, and accordingly there may be issues with respect to performance of the AF function.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module including a lens barrel accommodating a plurality of lenses disposed along an optical axis, and a lens holder coupled to the lens barrel; a carrier accommodating the lens module; a first driver configured to provide a driving force to move the lens module in an optical axis direction; a first ball assembly and a second ball assembly configured to guide the lens module as the lens module moves in the optical axis direction; a housing accommodating the carrier; and a case coupled to the housing, wherein the case includes a step portion opposing the first ball assembly in the optical axis direction, and an upper end of the housing opposing the step portion in the optical axis direction is lower than an upper end of the carrier in the optical axis direction.

The step portion may have a quadrangular cross-section perpendicular to the optical axis.

The step portion may be connected to an edge of the case.

A number of balls in the first ball assembly may be different from a number of balls in the second ball assembly.

The lens barrel may be disposed between the first ball assembly and the second ball assembly.

The camera module may further include a guide member disposed in the carrier and configured to be movable together with the lens module in the optical axis direction; a second driver configured to provide a driving force to move the lens module; and a third driver configured to provide a driving force to move the lens module.

The camera module may further include a connection magnet disposed between the lens holder and the carrier.

Each of the lens holder and the guide member may include a first rolling groove having a length in a first direction perpendicular to the optical axis.

Each of the guide member and the carrier may include a second rolling groove having a length in a second direction perpendicular to the optical axis.

The second driver may include a second magnet and a second coil, the third driver may include a third magnet and a third coil, the second magnet may be mounted on the lens holder, and the third magnet may be mounted on the guide member.

The carrier may include guide grooves configured to guide movements of the first ball assembly and the second ball assembly.

The first driver may be one of first drivers configured to provide driving forces to move the lens module in the optical axis direction, the first drivers may include first magnets and first coils, the first magnets may be disposed on side surfaces of the carrier in which the guide grooves are formed, and the first coils may oppose the first magnets.

In another general aspect, a camera module includes a housing having an internal space; a carrier disposed in the internal space of the housing and configured to be movable in an optical axis direction; a lens module disposed in the carrier, the lens module including a plurality of lenses; a first ball assembly and a second ball assembly disposed between the carrier and the housing and spaced apart from each other in a direction perpendicular to the optical axis direction; and a case coupled to the housing, wherein a number of balls in the first ball assembly may be less than a number of balls in the second ball assembly, the case may include a step portion opposing the first ball assembly in the optical axis direction, and a dimple opposing the second ball assembly in the optical axis direction, and a surface of the step portion opposing the first ball assembly may be lower than a bottom surface of the dimple opposing the second ball assembly in the optical axis direction.

The step portion may be connected to an edge of the case.

A cross-sectional area of the step portion perpendicular to the optical axis direction may be larger than a cross-sectional area of the dimple perpendicular to the optical axis direction.

The surface of the step portion and the bottom surface of the dimple are lower than an upper surface of the case in the optical axis direction.

In another general aspect, a camera module includes a lens module including a lens barrel accommodating a plurality of lenses disposed along an optical axis, and a lens holder coupled to the lens barrel; a carrier accommodating the lens module; a first driver configured to apply a driving force to the carrier to move the carrier and the lens module accommodated in the carrier in an optical axis direction; a first ball assembly and a second ball assembly configured to guide the carrier as the carrier moves in the optical axis direction; a housing accommodating the carrier; and a case coupled to the housing and configured to retain the first ball assembly and the second ball assembly in the camera module, wherein the case includes a first portion opposing the first ball assembly in the optical axis direction and having a first height in the optical axis direction; and a second portion opposing the second ball assembly in the optical axis direction and having a second height in the optical axis direction different from the first height in the optical axis direction.

The first portion of the case opposing the first ball assembly in the optical axis direction may be a step portion having the first height in the optical axis direction, the second portion of the case opposing the second ball assembly in the optical axis direction may be a dimple formed in an upper surface of the case and having a bottom surface having the second height in the optical axis direction, the first height of the step portion in the optical axis direction may be less than the second height of the bottom surface of the dimple in the optical axis direction, and the first height of the step portion in the optical axis direction and the second height of the bottom surface of the dimple in the optical axis direction may be less than a third height in the optical axis of the upper surface of a remaining portion of the case.

The first portion of the case may have a quadrangular cross-section perpendicular to the optical axis, and the second portion of the case may have a circular cross-section perpendicular to the optical axis.

The camera module may further include a guide member disposed between the lens module and the carrier; a second driver configured to apply a driving force to the lens module to move the lens module relative to the guide member and the carrier in a first direction perpendicular to the optical axis direction; and a third driver configured to apply a driving force to the guide member to move the lens module and the guide member relative to the carrier in a second direction perpendicular to both the first direction and the optical axis direction.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of the camera module of FIG. 1.

FIG. 3 is a perspective view of a case of the camera module of FIGS. 1 and 2.

FIG. 4 is an exploded perspective view of a lens module, a guide member, and a carrier of the camera module of FIGS. 1 and 2.

FIG. 5 is a bottom perspective view of the lens module and the guide member of FIG. 4.

FIG. 6 is a perspective view of a first driver, a second driver, and a third driver of the camera module of FIGS. 1 and 2.

FIG. 7 is a side view of a first magnet, a second magnet, and a third magnet of the first driver, the second driver, and the third driver of FIG. 6.

FIG. 8A is a cross-sectional view taken along the line VIIIA-VIIIA′ of FIG. 1, FIG. 8B is a cross-sectional view taken along the line VIIIB-VIIIB′ of FIG. 1, and FIG. 8C is a cross-sectional view taken along the line VIIIC-VIIIC′ of FIG. 1.

FIG. 9 is a perspective view of a housing and a ball assembly of the camera module of FIGS. 1 and 2.

FIG. 10 is a schematic plan view of the camera module of FIGS. 1 and 2 without the case viewed in an optical axis direction.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

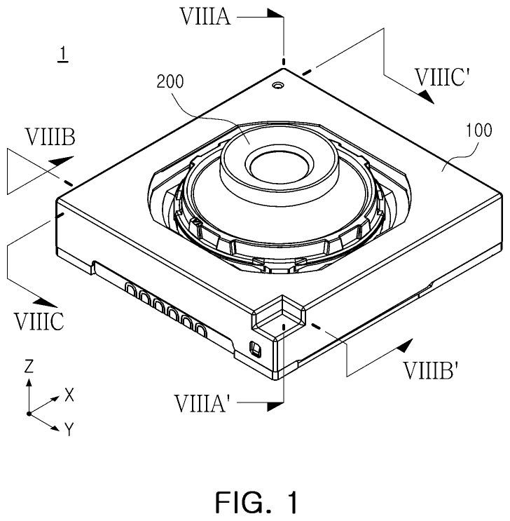

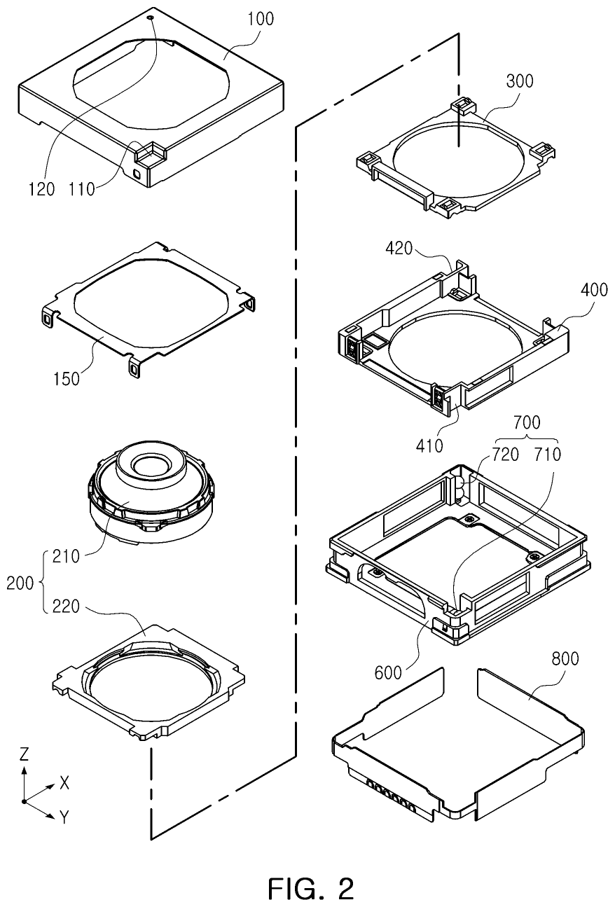

FIG. 1 is a perspective view of a camera module according to an embodiment of the present disclosure. FIG. 2 is an exploded perspective view of the camera module of FIG. 1.

Referring to FIGS. 1 and 2, a camera module 1 according to an embodiment of the present disclosure may include a case 100, a stopper 150, a lens module 200, a guide member 300, a carrier 400, a housing 600, and a ball assembly 700. Hereinafter, for ease of description, “upper” denotes a direction in an optical axis direction Z toward a source of incident light entering the camera module 1.

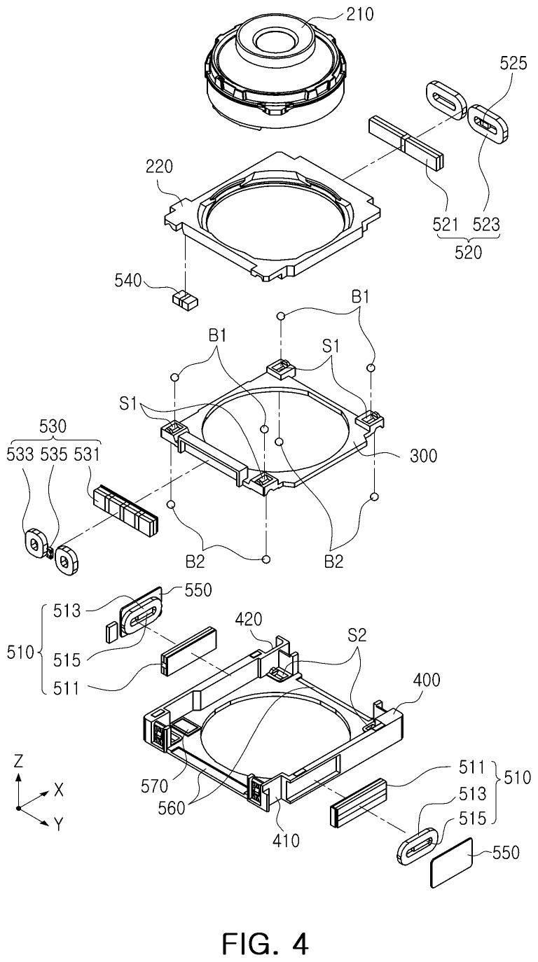

A stopper 150 is disposed over the lens barrel 210 and fastened to the carrier 400 to keep the lens barrel 210, the lens holder 220, the guide member 300, ball members S1, and the carrier 400 from separating from each other. The ball members S1 will be described later in connection with FIG. 4.

The lens module 200 may include a lens barrel 210, and a lens holder 220 coupled to the lens barrel 210.

The lens barrel 210 may include a plurality of lenses. For example, the lens barrel 210 may have a hollow cylindrical shape to accommodate lenses therein, and the plurality of lenses may be mounted in the lens barrel 210 along an optical axis.

The lens holder 220 may be coupled to the lens barrel 210. The lens barrel 210 may move while being coupled to the lens holder 220.

The guide member 300 may be disposed on a lower portion of the lens holder 220, and may be movable together with the lens module 210 in the optical axis direction Z.

The carrier 400 may accommodate the lens module 200 and the guide member 300. For example, the lens module 200 and the guide member 300 accommodated in the carrier 400 may move together in the optical axis direction Z. The carrier 400 may have guide grooves 410 and 420 to guide a movement of the ball assembly 700.

The ball assembly 700 is accommodated in the housing 600, and may guide a movement of the lens module 200 in the optical axis direction Z. The ball assembly 700 may include a first ball assembly 710 and a second ball assembly 720. The first ball assembly 710 and the second ball assembly 720 may be disposed at different positions. For example, the first ball assembly 710 and the second ball assembly 720 may be spaced apart from each other in a direction perpendicular to the optical axis direction Z. In addition, the first ball assembly 710 and the second ball assembly 720 may be spaced apart from each other in a diagonal direction of the housing 600.

Each of the first ball assembly 710 and the second ball assembly 720 may include at least one ball, and the number of balls included in the first ball assembly 710 may be different from the number of balls included in the second ball assembly 720. For example, the number of balls included in the first ball assembly 710 may be less than the number of balls included in the second ball assembly 720.

The housing 600 may accommodate the carrier 400 and the ball assembly 700. Portions of the upper end of the housing 600 may have different heights in the optical axis direction. For example, the housing 600 in the optical axis direction Z may have a height varying according to a position in the housing.

The housing 600 may include a plurality of through-holes. Although not illustrated in FIG. 2, a plurality of coils as shown in FIG. 4 may be disposed in the through-holes. The plurality of coils may be disposed on a substrate 800, and the substrate 800 may be coupled to the housing 600.

The case 100 may be coupled to the housing 600 and surround an outer surface of the housing 600. The case 100 may include a hollow hole to accommodate the lens barrel 210, and may include a step portion 110. For example, the step portion 110 may be formed in an upper surface of the case 100. In the case 100, the step portion 110 may be disposed at a position opposing a position of the ball assembly 700 in the optical axis direction Z. For example, the step portion 110 may be disposed at a position opposing a position of the first ball assembly 710 in the optical axis direction Z, and may extend to an edge of the case 100. Accordingly, the step portion 110 may be connected to the edge of the case 100.

A dimple 120 may be additionally formed in the case 100. For example, in the case 100, the dimple 120 may be disposed at a position opposing a position of the second ball assembly 720 in the optical axis direction Z. The first ball assembly 710 and the second ball assembly 720 may be spaced apart from each other so that they are disposed at different positions, and therefore the step portion 110 and the dimple 120 may also be spaced apart from each other so that they are disposed at different positions.

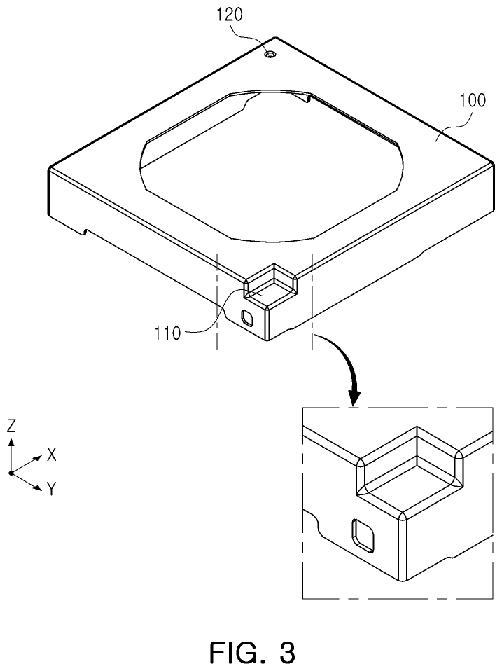

FIG. 3 is a perspective view of a case according to an embodiment of the present disclosure.

Referring to FIG. 3, an upper surface of the case 100 may include a step portion 110 and a dimple 120 having different heights in the optical axis direction Z. In the case 100, a surface of the step portion 110 and a bottom surface of the dimple 120 may be disposed at positions lower than to position of the upper surface of the case 100 in the optical axis direction Z.

In an embodiment of the present disclosure, the upper surface of the case 100 may have a quadrangular shape. The step portion 110 may be disposed at a corner portion of the upper surface of the case 100, and may be connected to an edge of the case 100. The dimple 120 may be disposed at another corner portion of the upper surface of the case 100, but may be spaced apart from the edge of the case 100. For example, in the case 100, the dimple 120 and the step portion 110 may be spaced apart from each other in a diagonal direction of the case 100.

The dimple 120 and the step portion 110 may have different widths on the upper surface of the case 100 and different heights in the optical axis direction Z. For example, the step portion 110 may have a quadrangular cross-section perpendicular to the optical axis, and the dimple 120 may have a circular cross-section perpendicular to the optical axis. Referring to FIG. 3, a cross-sectional area of the step portion 110 perpendicular to the optical axis may be larger than a cross-sectional area of the dimple 120 perpendicular to the optical axis. In addition, the surface of the step portion 110 may be disposed at a height in the optical axis direction Z that is different from a height of the bottom surface of the dimple 120 in the optical axis direction Z. For example, the bottom surface of the step portion 110 may be disposed at a position in the optical axis direction Z that is lower than a position of the surface of the dimple 120 in the optical axis direction Z.

FIG. 4 is an exploded perspective view of a lens module, a guide member, and a carrier of the camera module of FIGS. 1 and 2, and FIG. 5 is a bottom perspective view of the lens module and the guide member of FIGS. 1 and 2.

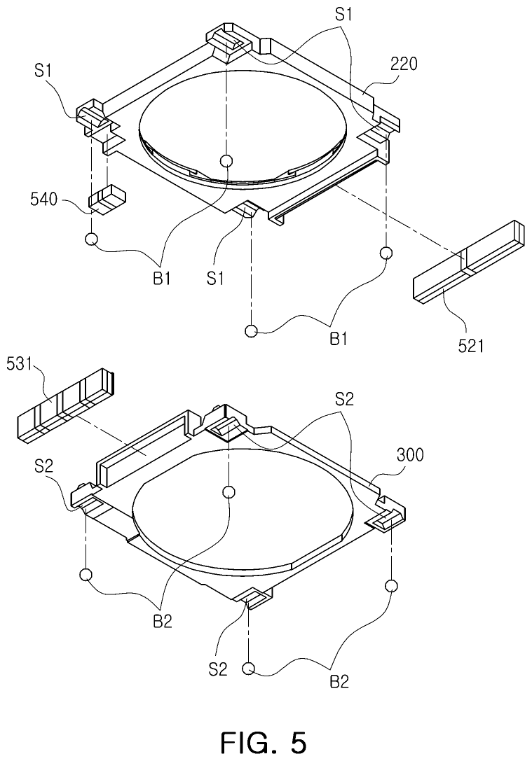

Referring to FIGS. 4 and 5, the camera module 1 may include the lens barrel 210, the lens holder 220, the guide member 300, the carrier 400, and a plurality of ball members B1 and B2.

The carrier 400 may accommodate the lens holder 220 and the lens barrel 210, and may move the lens module 200 in the optical axis direction Z.

In order to move the lens module 200 in the optical axis direction Z, first drivers 510 may be disposed on the carrier 400.

The first drivers 510 may include first magnets 511 and a first coils 513.

The first magnets 511 may be mounted on the carrier 400. For example, the carrier 400 may have the guide grooves 410 and 420 guiding a movement of the ball assembly 700, and the first magnets 511 may be disposed on side surfaces of the carrier 400 having the guide grooves 410. For example, the first magnets 511 may be disposed adjacent to the guide grooves 410 and 420.

For example, the first magnets 511 may be spaced apart from each other in a diagonal direction of the carrier 400 on side surfaces of the carrier 400 opposing each other in a second direction Y.

The first coils 513 may be disposed to oppose the first magnets 511. For example, the housing 600 may have through-holes in which the first coils 513 are disposed, and the first coils 513 may be disposed in the through-holes to oppose the first magnets 511 in the second direction Y. The first coils 513 may be mounted on the substrate 800 coupled to the housing 600.

A second driver 520 may include a second magnet 521 and second coils 523.

The second magnet 521 may be mounted on the lens holder 220. For example, the second magnet 521 may be disposed on a side surface of the lens holder 220.

The second coils 523 may be disposed to oppose the second magnet 521. For example, the housing 600 may have a through-hole in which the second coils 523 are disposed, and the second coils 523 may be disposed in the through-hole to oppose the second magnet 521 in a first direction X.

A third driver 530 may include a third magnet 531 and third coils 533.

The third magnet 531 may be mounted on the guide member 300. For example, the third magnet 531 may be disposed on a side surface of the guide member 300.

The third coils 533 may be disposed to oppose the third magnet 531. For example, the housing 600 may have a through-hole in which the third coils 533 are disposed, and the third coils 533 may be disposed in the through-hole to oppose the third magnet 531 in the first direction X.

Referring to FIGS. 4 and 5, the lens holder 220, the guide member 300 and the carrier 400 may be sequentially stacked along an optical axis.

First ball members B1 may be disposed between the lens holder 220 and the guide member 300. First rolling grooves S1 may be formed in a lower surface of the lens holder 220, and may also be formed in an upper surface of the guide member 300 at positions corresponding to the positions of the first rolling grooves S1 formed in the lower surface of the lens holder 220. The first ball members B1 may perform a rolling motion along the first rolling grooves S1. For example, the first rolling grooves S1 may be formed to have a length in the first direction X. Accordingly, the first ball members B1 may perform a rolling motion in the first direction X. That is, the lens holder 220 may be movable in the first direction X, and the lens barrel 210 coupled to the lens holder 220 may also be movable in the first direction X.

Second ball members B2 may be disposed between the guide member 300 and the carrier 400. Second rolling grooves S2 may be formed in a lower surface of the guide member 300, and may also be formed in an upper surface of the carrier 400 at positions corresponding to the positions of the second rolling grooves S2 formed in the lower surface of the guide member 300. The second ball members B2 may perform a rolling motion along the second rolling groove S2. For example, the second rolling grooves S2 may be formed to have a length in the second direction Y. Accordingly, the second ball members B2 may perform a rolling motion in the second direction Y. That is, the guide member 300 may be movable in the second direction Y, and the lens module 200 and the guide member 300 may be sequentially stacked in the optical axis direction, so that the lens module 200 may also be movable in the second direction Y.

That is, in an embodiment of the present disclosure, the first rolling grooves S1 and the second rolling grooves S2 may be formed perpendicular to each other in the upper and lower surfaces of the guide member 300. The lens module 200 may move on the upper surface of the guide member 300 along the first rolling grooves S1 in the first direction X, and the guide member 300 may move on the upper surface of the carrier 400 in the second direction Y, and accordingly the lens module 200 may move in the second direction Y. That is, the lens module 200 may be movable in the first direction X and the second direction Y, which are perpendicular to the optical axis, thereby compensating for shaking of the camera module 1.

The camera module 1 may include first yoke members 550, second yoke members 560, and a third yoke member 570.

The first yoke members 550 may be disposed to oppose the first coils 513. For example, the first magnets 511, the first coils 513, and the first yoke members 550 may be sequentially disposed in the second direction Y. Attractive forces may act between the first yoke members 550 and the first magnets 511, and the first coils 513 may be disposed in a fixed state.

The second yoke members 560 may be disposed along edges of the upper surface of the carrier 400. For example, the second yoke members 560 may be disposed along opposite edges of the upper surface of the carrier 400 in the first direction X. The second yoke members 560 may be disposed on the carrier 400, and attractive forces act between the second yoke members 560 and the second magnet 521 and the third magnet 531 to maintain a state in which the lens module 200, the guide member 300, and the carrier 400 are stacked in the optical axis direction.

The third yoke member 570 may be disposed on the upper surface of the carrier 400. A connection magnet 540 opposing the third yoke member 570 may be additionally provided between the lens module 200 and the carrier 400. The lens module 200 and the guide member 300 may be accommodated in the carrier 400, and the connection magnet 540 may maintain a state in which the lens module 200, the guide member 300, and the carrier 400 are sequentially stacked in the optical axis direction. For example, the connection magnet 540 may be disposed on the lower surface of the lens holder 220 so that an attractive force acts between the lens holder 220 and the third yoke member 570 disposed on the upper surface of the carrier 400.

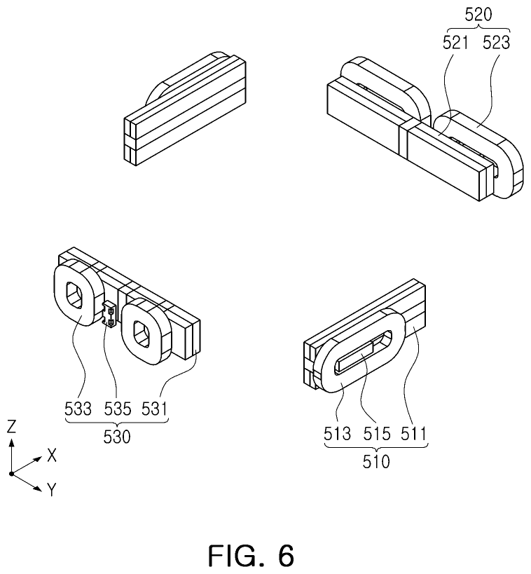

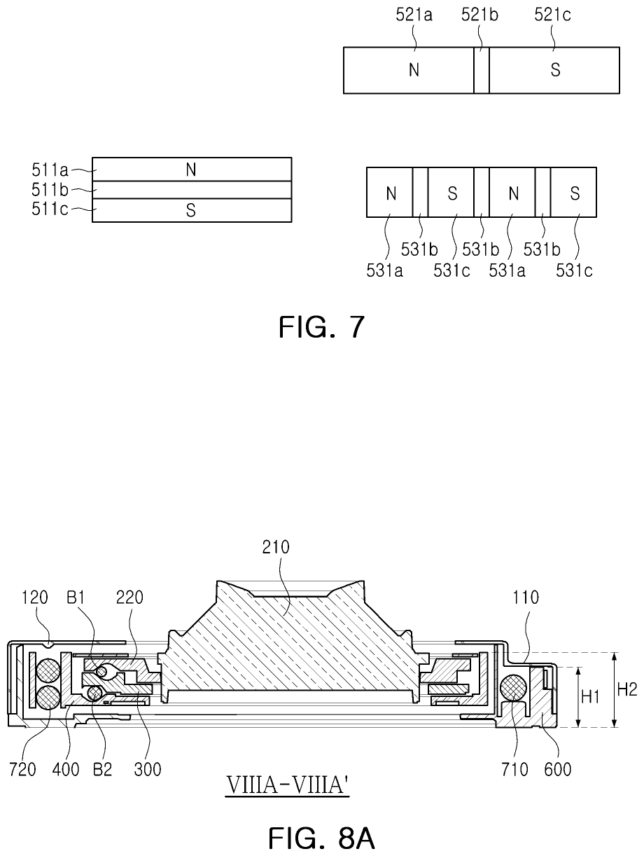

FIG. 6 is a perspective view of a first driver, a second driver, and a third driver of the camera module of FIGS. 1 and 2. FIG. 7 is a side view of a first magnet, a second magnet, and a third magnet of the first driver, the second driver, and the third driver of FIG. 6.

Referring to FIGS. 6 and 7, the first magnets 511 may have a first polarity 511a, a neutral region 511b, and a second polarity 511c, and may be elongated in the first direction X. For example, the first magnets 511 may be magnetized so that surfaces thereof opposing the first coils 513 have the first polarity 511a, the neutral region 511b, and the second polarity 511c sequentially arranged in the optical axis direction Z.

The second magnet 521 may include a first polarity 521a, a neutral region 521b, and a second polarity 521c, and may be elongated in the second direction Y. For example, the second magnet 521 may be magnetized so that a surface thereof opposing the second coil 523 has the first polarity 521a, the neutral region 521b, and the second polarity 521c sequentially arranged in the second direction Y.

The third magnet 531 may include a plurality of first polarities 531a, a plurality of neutral regions 531b, and a plurality of second polarities 531c, and may be formed to be elongated in the second direction Y. For example, the third magnet 531 may be magnetized so that a surface thereof opposing the third coil 533 has a first polarity 531a, a neutral region 531b, a positive polarity 531c, a neutral portion 531b, a first polarity 531a, a neutral portion 531b, and a second polarity 531c sequentially arranged in the second direction Y.

The camera module 1 according to an embodiment of the present disclosure may use a closed loop control method of detecting and feeding back a position of the lens module 200.

Accordingly, first position sensors 515, a second position sensor 525, and a third position sensor 535 capable of detecting the position of the lens module 200 may be provided.

The first position sensors 515 may be disposed in the corresponding through-holes of the housing 600 and may be disposed inside the first coils 513. The first position sensors 515 may be disposed to oppose the first magnets 511. For example, the first position sensors 515 may be disposed to oppose the neutral regions 511b of the first magnets 511.

The second position sensor 525 may be disposed in the corresponding through-hole of the housing 600 and may be disposed inside one of the second coils 523. The second position sensor 525 may be disposed to oppose the second magnet 521. For example, the second position sensor 525 may be disposed to oppose the first polarity 521a of the second magnet 521.

The third position sensor 535 may be disposed in the corresponding through-hole of the housing 600 and may be disposed outside the third coils 533. For example, the third position sensor 535 may be provided between the third coils 533. The third position sensor 535 may be disposed to oppose the third magnet 531. For example, the third position sensor 535 may be disposed to oppose the center neutral region 531b of the third magnet 531.

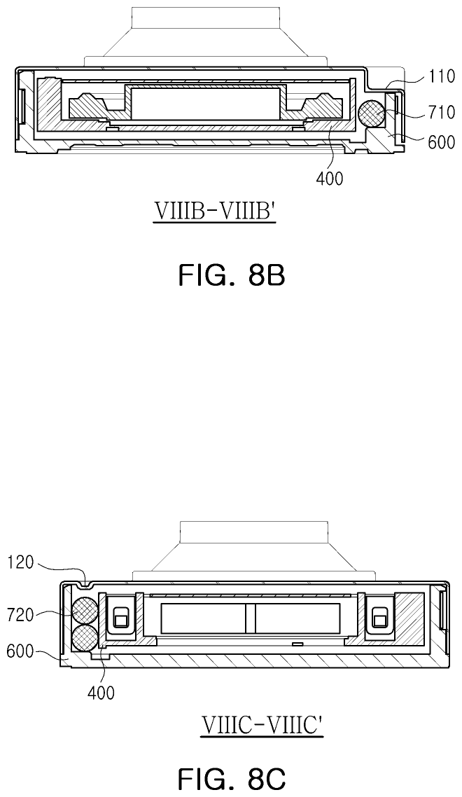

FIG. 8A is a cross-sectional view taken along the line VIIIA-VIIIA′ of FIG. 1, FIG. 8B is a cross-sectional view taken along the line VIIIB-VIIIB′ of FIG. 1, and FIG. 8C is a cross-sectional view taken along the line VIIIC-VIIIC′ of FIG. 1.

Referring to FIGS. 8A, 8B, and 8C, the camera module 1 according to an embodiment of the present disclosure may include the lens module 200, the guide member 300, the carrier 400, the housing 600, the case 100, and the ball assembly 700.

The carrier 400 may accommodate the lens barrel 210, the lens holder 220, and the guide member 300. The carrier 400 may accommodate the lens barrel 210, the lens holder 220, and the guide member 300 in the optical axis direction Z, and may have a height in the optical axis direction Z.

The ball assembly 700 may be in contact with the carrier 400, and may guide the lens module 200 to move in the optical axis direction Z. For example, the ball assembly 700 may be disposed between the housing 600 and the carrier 400, and the carrier 400 may be movable in a rolling manner along the ball assembly 700 in the optical axis direction Z.

Since the carrier 400 is movable along the ball assembly 700 in the optical axis direction Z, a position H2 of an upper end of the carrier 400 in the optical axis direction Z may change. FIG. 8A illustrates a case in which the carrier 400 is disposed at a lowest position in the optical axis direction Z. That is, the position H2 of the upper end of the carrier 400 in the optical axis direction Z may be equal to or higher than the position H2 illustrated in FIG. 8A.

The case 100 may have the step portion 110, and the upper end of the housing 600 opposing the step portion 110 in the optical axis direction Z may have a height H1 in the optical axis direction that is shorter than a height of a remaining portion of the upper end of the housing 600 in the optical axis direction. Referring to FIG. 8A, the position H2 of the upper end of the carrier 400 in the optical axis direction Z illustrated in FIG. 8A is a lowest position of the upper end of the carrier 400. Even when the position H2 of the upper end of the carrier 400 changes in the optical axis direction Z as the carrier 400 moves in the optical axis direction Z, the position H2 of the upper end of the carrier 400 in the optical axis direction Z will always be higher than the height H1 in the optical axis direction Z of the upper end of the housing 600 opposing the step portion 110 in the optical axis direction Z. Accordingly, the upper end of the housing 600 opposing the step portion 110 of the case 100 in the optical axis direction Z may be disposed at a height H1 that is lower than the position H2 of the upper end of the carrier 400 in the optical axis direction Z.

The case 100 may include the step portion 110 and the dimple 120 both extending toward the ball assembly 700 in the optical axis direction Z.

According to an embodiment of the present disclosure, the step portion 110 may be disposed at a position from which it extends toward the first ball assembly 710 in the optical axis direction Z, and the dimple 120 may be disposed at a position from which it extends toward the second ball assembly 720 in the optical axis direction Z. In addition, the number of balls included in the first ball assembly 710 may be less than the number of balls included in the second ball assembly 720, and the surface of the step portion 110 may be disposed at a position lower than a position of the bottom surface of the dimple 120 in the optical axis direction Z.

Referring to FIGS. 8B and 8C, the ball assembly 700 may be disposed between the carrier 400 and the housing 600. The carrier 400 may accommodate the lens module 200 and the guide member 300, and may move in the optical axis direction Z. The carrier 400 may be movable in the optical axis direction Z, and a position of the carrier 400 in the optical axis direction Z may change depending on a position of the lens barrel 210. In this case, a movable range of the carrier 400 may be limited by the case 100, and the upper end of the carrier 400 may be disposed at the position H2 in the optical axis direction Z that is higher than the height H1 of the upper end of the housing 600 opposing the step portion 110 of the case 100 in the optical axis direction Z.

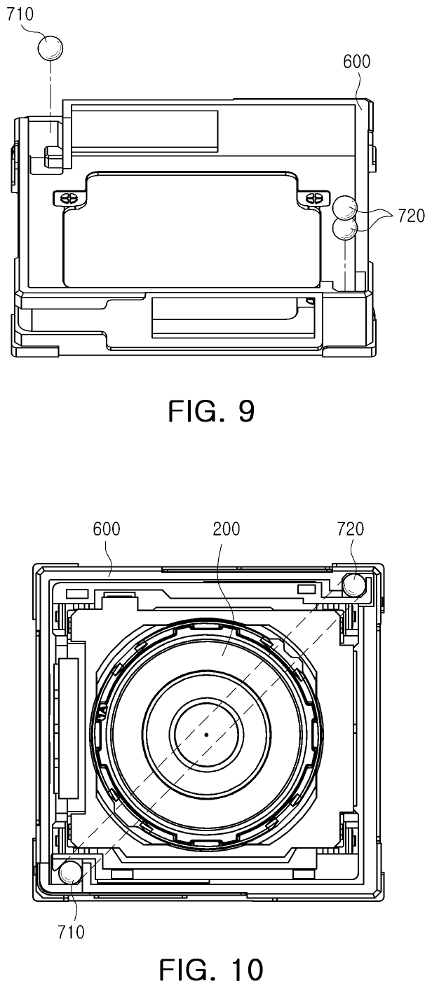

FIG. 9 is a perspective view of a housing and a ball assembly of the camera module of FIGS. 1 and 2. FIG. 10 is a schematic plan view of the camera module of FIGS. 1 and 2 without the case viewed in an optical axis direction.

Referring to FIGS. 9 and 10, in an embodiment of the present disclosure, the first ball assembly 710 and the second ball assembly 720 may be disposed in corner portions of the housing 600. For example, the first ball assembly 710 and the second ball assembly 720 may be disposed in the housing 600 spaced apart from each other in a diagonal direction of the housing 600. Referring to FIG. 9, a height of an upper end of a portion of the housing 600 adjacent to the first ball assembly 710 in the optical axis direction Z may be lower than a height of the upper portion of a remaining portion of the housing 600 in the optical axis direction Z.

Through-holes may be formed in the side surfaces of the housing 600. The first coils 513, the second coil 523, and the third coil 533 may be disposed in the through-holes. In addition, the first position sensors 515, the second position sensor 525, and the third position sensor 535 may be disposed in the through-holes, and circuit devices (driver ICs) providing driving signals to the first coils 513, the second coil 523, and the third coil 533 may be disposed together with the first position sensors 515, the second position sensor 525, and the third position sensor 535.

Referring to FIG. 10, the first ball assembly 710 and the second ball assembly 720 may be disposed in the housing 600 spaced apart from each other in a direction perpendicular to the optical axis. For example, the first ball assembly 710 and the second ball assembly 720 may be disposed at the corner portions of the housing 600 in the diagonal direction of the housing 600, and may be accommodated in spaces between the guide grooves 410 and 420 of the carrier 400 and the housing 600. The lens module 200 may be disposed in a central portion of the housing 600, and thus may be disposed between the first ball assembly 710 and the second ball assembly 720.

For example, the central portion (for example, the optical axis) of the lens module 200 may be disposed in a region indicated by the dashed lines in FIG. 10 defined by imaginary lines connecting opposite sides of the first ball assembly 710 to opposite sides of the second ball assembly 720.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens module comprising a lens barrel accommodating a plurality of lenses disposed along an optical axis, and a lens holder coupled to the lens barrel;
a carrier accommodating the lens module;
a first driver configured to provide a driving force to move the lens module in an optical axis direction;
a first ball assembly and a second ball assembly configured to guide the lens module as the lens module moves in the optical axis direction;
a housing accommodating the carrier; and
a case coupled to the housing,
wherein the case comprises a step portion opposing the first ball assembly in the optical axis direction, and
an upper end of the housing opposing the step portion in the optical axis direction is lower than an upper end of the carrier in the optical axis direction.

2. The camera module of claim 1, wherein the step portion has a quadrangular cross-section perpendicular to the optical axis.

3. The camera module of claim 1, wherein the step portion is connected to an edge of the case.

4. The camera module of claim 1, wherein a number of balls in the first ball assembly is different from a number of balls in the second ball rolling assembly.

5. The camera module of claim 1, wherein the lens barrel is disposed between the first ball assembly and the second ball assembly.

6. The camera module of claim 1, further comprising:
a guide member disposed in the carrier and configured to be movable together with the lens module in the optical axis direction;
a second driver configured to provide a driving force to move the lens module; and
a third driver configured to provide a driving force to move the lens module.

7. The camera module of claim 6, further comprising a connection magnet disposed between the lens holder and the carrier.

8. The camera module of claim 6, wherein each of the lens holder and the guide member comprises a first rolling groove having a length in a first direction perpendicular to the optical axis.

9. The camera module of claim 8, wherein each of the guide member and the carrier comprises a second rolling groove having a length in a second direction perpendicular to the optical axis.

10. The camera module of claim 6, wherein the second driver comprises a second magnet and a second coil,
the third driver comprises a third magnet and a third coil,
the second magnet is mounted on the lens holder, and
the third magnet is mounted on the guide member.

11. The camera module of claim 1, wherein the carrier comprises guide grooves configured to guide movements of the first ball assembly and the second ball rolling assembly.

12. The camera module of claim 11, wherein the first driver is one of first drivers configured to provide driving forces to move the lens module in the optical axis direction,
the first drivers comprise first magnets and first coils,
the first magnets are disposed on side surfaces of the carrier in which the guide grooves are formed, and
the first coils oppose the first magnets.

13. A camera module comprising:
a housing having an internal space;
a carrier disposed in the internal space of the housing and configured to be movable in an optical axis direction;
a lens module disposed in the carrier, the lens module comprising a plurality of lenses;
a first ball assembly and a second ball assembly disposed between the carrier and the housing and spaced apart from each other in a direction perpendicular to the optical axis direction; and
a case coupled to the housing,
wherein a number of balls in the first ball assembly is less than a number of balls in the second ball assembly,
the case comprises a step portion opposing the first ball assembly in the optical axis direction, and a dimple opposing the second ball assembly in the optical axis direction, and
a surface of the step portion opposing the first ball assembly is lower than a bottom surface of the dimple opposing the second ball assembly in the optical axis direction.

14. The camera module of claim 13, wherein the step portion is connected to an edge of the case.

15. The camera module of claim 13, wherein a cross-sectional area of the step portion perpendicular to the optical axis direction is larger than a cross-sectional area of the dimple perpendicular to the optical axis direction.

16. The camera module of claim 13, wherein the surface of the step portion and the bottom surface of the dimple are lower than an upper surface of the case in the optical axis direction.

17. A camera module comprising:
a lens module comprising a lens barrel accommodating a plurality of lenses disposed along an optical axis, and a lens holder coupled to the lens barrel;
a carrier accommodating the lens module;
a first driver configured to apply a driving force to the carrier to move the carrier and the lens module accommodated in the carrier in an optical axis direction;
a first ball assembly and a second ball assembly configured to guide the carrier as the carrier moves in the optical axis direction;
a housing accommodating the carrier; and
a case coupled to the housing and configured to retain the first ball assembly and the second ball assembly in the camera module,
wherein the case comprises:
a first portion opposing the first ball assembly in the optical axis direction and having a first height in the optical axis direction; and
a second portion opposing the second ball assembly in the optical axis direction and having a second height in the optical axis direction different from the first height in the optical axis direction.

18. The camera module of claim 17, wherein the first portion of the case opposing the first ball assembly in the optical axis direction is a step portion having the first height in the optical axis direction,
the second portion of the case opposing the second ball assembly in the optical axis direction is a dimple formed in an upper surface of the case and having a bottom surface having the second height in the optical axis direction,
the first height of the step portion in the optical axis direction is less than the second height of the bottom surface of the dimple in the optical axis direction, and
the first height of the step portion in the optical axis direction and the second height of the bottom surface of the dimple in the optical axis direction are less than a third height in the optical axis of the upper surface of a remaining portion of the case.

19. The camera module of claim 17, wherein the first portion of the case has a quadrangular cross-section perpendicular to the optical axis, and
the second portion of the case has a circular cross-section perpendicular to the optical axis.

20. The camera module of claim 17, further comprising:
a guide member disposed between the lens module and the carrier;
a second driver configured to apply a driving force to the lens module to move the lens module relative to the guide member and the carrier in a first direction perpendicular to the optical axis direction; and
a third driver configured to apply a driving force to the guide member to move the lens module and the guide member relative to the carrier in a second direction perpendicular to both the first direction and the optical axis direction.
